(19) United States
(12) Patent Application Publication
(10) Pub. No.: US 2004/0011993 A1
(43) Pub. Date: Jan. 22, 2004

(54) Acid neutralizing composition, sheet and method

(76) Inventors: Scott D. Ficken, Dallas, TX (US); Dennis W. Peterson, Dallas, TX (US); Gary Cude, Plano, TX (US)

Correspondence Address: FISH & RICHARDSON P.C., 1425 K STREET, N.W., 11TH FLOOR, WASHINGTON, DC, 20005-3500, US

(21) Appl. No.: 10/197,260

(22) Filed: Jul. 18, 2002

(51) Int. Cl. C09K 3/00

(52) U.S. Cl. 252/189

(57) ABSTRACT

Acid neutralizing composition, sheet and method of using the same allow control of the pH of surfaces that form and contact an object such as, a work of art, a historical artifact and a craft item. Controlling the pH of the surface can help preserve and protect the object from degrading over periods of storage or display. Acid neutralizing composition can be used on hands or any surface which contacts the object to neutralize acidic moieties on the surface of the object without leaving a residue on the hand or object.

### TECHNICAL FIELD

This invention relates to an acid neutralizing composition, sheet, and method of using the same.

### BACKGROUND

Materials used in objects, such as works of art, photographs, historical artifacts, and craft items, particularly those including paper or other cellulose-based materials, can be susceptible to degradation and destruction by a variety of exposure conditions. The inherent acidity of the materials or any acidic material or any other residue contacting the materials can contribute to degradation of these objects over a long period of time. Visible light energy in the presence of oxygen can initiate photo-oxidation which can lead to degradation and eventual destruction of the object. Each instance of exposure or continued exposure can add to and promote the cumulative degradation of the object. Objects, for example, papers, photographs and documents of a valuable character are particularly susceptible to disintegration due to contact with acidic contaminants. Artisans can use acid-free materials such as acid-free paper, markers and glue to control the amount of contaminant in an object.

### SUMMARY

In one aspect, an acid neutralizing composition includes an aqueous solution including an amine and an acid and being substantially free of fatty acids, fatty acid amides, fatty acid carboxylate salts and fatty acid esters.

In another aspect, a method of neutralizing acid on a surface includes contacting a surface with a composition comprising an aqueous solution including an amine and an acid and being substantially free of fatty acids, fatty acid amides, fatty acid carboxylate salts and fatty acid esters, thereby increasing pH of the surface. The surface can be skin of a mammal or a surface of a tool. The surface can be contacted by, for example, leaving a surface substantially free of residue or wiping the surface with a sheet including the composition. The pH of the surface can be increased from less than 7 (such as 5.5 to 6.9) to between 7 and 10 (such as 7.0 to 8.0). The pH of the surface can remain at or above pH 7 for at least 2 hours.

In another aspect, an acid neutralizing composition includes an amine and a pH adjuster in an aqueous medium wherein the composition is substantially free of moisturizers or emollients. The pH adjuster can include an acid or a salt, or mixtures thereof. The salt can be a carbonate salt or a soluble bicarbonate salt.

In another aspect, an acid neutralizing sheet includes a sheet, a composition including an aqueous solution including an amine and an acid and being substantially free of fatty acids, fatty acid amides, fatty acid carboxylate salts and fatty acid esters contacting the sheet, and a container retaining the sheet.

In another aspect, an acid neutralizing composition can consisting essentially of water, an amine, an inorganic acid, a carbonate salt and a nonionic surfactant. The composition of can contain a preservative.

In another aspect, a method of maintaining pH of a surface on a mammal includes applying a surface of a mammal with an effective amount of a composition including a pH adjusting agent being substantially free of fatty acids, fatty acid amides, fatty acid carboxylate salts and fatty acid esters to render the pH of the surface of the mammal neutral to mildly alkaline pH. The composition can be applied to the surface of the mammal with a first sheet. The method can include reapplying the effective amount of the composition to the surface of the mammal to maintain the pH on the surface. The composition can be reapplied to the surface of the mammal with a second sheet.

The amine can be a primary amine, secondary amine, tertiary amine, alkylamine, alkanol amine, diamine, dialkylamine, dialkanolamine, alkylalkanolamine, trialkylamine, trialkanolamine, dialkyl alkanolamine, alkyl dialkanolamine, ammonia or a mixture thereof. The trialkanolamine can be triethanolamine. The composition can contain 0.001% to 1% by weight of the amine.

The composition can include alkali metal hydroxides, alkaline earth metal hydroxides, alkali metal carbonates, alkaline earth metal carbonates, alkali metal bicarbonates, alkali earth metal bicarbonates or a mixture thereof. The composition can include a surfactant, such as a nonionic surfactant, for example, an alkylphenol ethoxylate. In certain circumstances, the composition includes a lower alcohol, such as ethyl alcohol.

The composition can include a preservative, such as methyl paraben.

The acid can be an inorganic acid. The acid can be acetic acid, phosphoric acid, orthophosphoric acid, metaphosphoric acid or phosphorous acid, citric acid, adipic acid, malic acid, malonic acid, phthalic acid, oxalic acid, succinic acid, sorbic acid, cinnamic acid, benzoic acid, hydroxybenzoic acid, glycolic acid, lactic acid, malic acid, muriatic acid, sulfamic acid, tartaric acid, glucuronic acid, or a mixture thereof. The composition can contain acid is 0.001% to 1% by weight of the acid.

Control of the pH of surfaces that form and contact an object such as a work of art, photographs, historical artifact, and craft item can help preserve and protect the object from degrading over periods of storage and/or display. For example, any residue from the artisan's hand can contribute to degradation of the object. The residue can be an acidic material or residual emollients or moisturizers on the artisan's hands. Acidity of an artisan's hand can be around pH of 5.5. Acidity of hands and on tools used by an artisan can inadvertently contribute the acidic material or moieties on a surface that contacts the object. If the artisan touches an object without neutralizing the acid on his hands, then the acid on the surface of the artisan's hand can contaminate the object, as, for example, fingerprints. Residues from emollients or moisturizers on the artisan's hands can further contaminate the object. When exposed to oxygen and light, the cellulose material can gradually disintegrates over time. An acid neutralizing composition can be applied during handling to, for example, hands or any other surface (i.e., a tool surface) that contacts an object to neutralize the acid on the surface that contacts the object. The composition can be formulated so that scrubbing or washing of the surface after contact with the composition is not needed. The composition can be formulated to be free of components, such as fatty acid derivatives, that do not leave a residue on the surface of the object when contacted by the hand or tool. The composition can help preserve and protect the object by neutralizing acid materials or moieties on the surface that contacts the object.

The details of one or more embodiments are set forth in the accompanying drawings and the description below. Other features, objects, and advantages will be apparent from the 0.30 description and drawings, and from the claims.

### DESCRIPTION OF DRAWINGS

FIG. 1 is a schematic of a container retaining a sheet material.

Like reference symbols in the various drawings indicate like elements.

### DETAILED DESCRIPTION

A composition can be formulated to control acidity of the surface, for example, hands of an artisan or tools used by the artisan. The composition can neutralize any surface in contact with an object by establishing and maintaining neutral or alkaline pH conditions. The composition can be substantially free of other residues such as, for example, fatty acids, fatty acid amides, fatty acid carboxylate salts and fatty acid esters. The composition can be used on to neutralize the pH of an acidic surface, for example, a tool used by the artisan in the formation of the object which contacts the object. The composition can be included in or on a sheet. The sheet can be used to neutralize acid on a hand of an artisan by applying the sheet to the hand. The composition can be reapplied after a period of time to maintain the neutral or alkaline pH conditions of hands of the artisan or the tool surface.

Acidity of a surface can be controlled by increasing the pH of a surface. Increasing the pH of a surface can include neutralizing acidic materials or moieties on the surface by basic moieties in the composition which contacts the surface. The acidic moieties can be groups that generate or release hydrogen ions, such as, for example, surface hydroxyl, carboxyl or ammonium groups.

The composition can include several ingredients, for example, an amine, which can act as a source of a basic moiety, and a pH adjuster, for example, an acid. The composition can include additional ingredients, for example, surfactants, preservatives or other additives. The composition can modify the pH of a surface of an object by changing the ambient pH of the surface, from, for example, less than 7 to at least 7, or from between 5.5 and 6.9 to between 7.0 and 8.0. The pH of the surface can be modified by the reducing or preventing the formation of hydrogen ions at the surface.

The amine can be ammonia, a primary amine, secondary amine, tertiary amine, alkylamine, alkanol amine, diamine, dialkylamine, dialkanolamine, alkylalkanolamine, trialkylamine, trialkanolamine, dialkyl alkanolamine, alkyl dialkanolamine or mixtures thereof. An example of a trialkanolamine can include, for example, triethanolamine. The composition can contain about 0.001% to about 10%, about 0.01% to about 5%, or about 0.01% to about 1% by weight of amine. In certain circumstances, the composition can contain less than 0.5% by weight of the amine.

The composition can include one or more pH adjusters. The pH adjuster can be an acid or a salt. Examples of the acid can be a mineral acid or a polycarboxylic acid, for example, acetic acid, phosphoric acid, phosphoric acid, orthophosphoric acid, metaphosphoric acid or phosphorous acid, citric acid, adipic acid, malic acid, malonic acid, phthalic acid, oxalic acid, succinic acid, sorbic acid, cinnamic acid, benzoic acid, hydroxybenzoic acid, glycolic acid, lactic acid, malic acid, muriatic acid, sulfamic acid, tartaric acid, glucuronic acid or mixtures thereof. In certain circumstances, the acid can be an inorganic acid, for example, phosphoric acid, orthophosphoric acid, metaphosphoric acid or phosphorous acid. The pH adjuster can be a salt, such as a water-soluble carbonate salt, hydroxide salt, or bicarbonate salt, for example, an alkali metal hydroxide, alkaline earth metal hydroxide, alkali metal carbonate, alkaline earth metal carbonate, alkali metal bicarbonate, alkali earth metal bicarbonate, or mixtures thereof. Examples include sodium carbonate, potassium carbonate, calcium hydroxide, sodium hydroxide, magnesium hydroxide, potassium hydroxide, sodium bicarbonate, magnesium oxide, calcium oxide, and mixtures thereof. The composition can contain less than about 10% by weight of pH adjuster, greater than about 0.001% by weight of pH adjuster, or about 0.005% to about 5%, about 0.01% to about 1%, or about 0.025% to about 0.1% by weight of pH adjuster.

The composition can be formulated so that scrubbing or washing of the surface is not needed after contact with the composition. The composition is formulated so that it does not leave a residue on the surface. The composition can be substantially free of fatty acids, fatty acid amides, fatty acid carboxylate salts and fatty acid esters which can leave a residue on the object. A fatty acid is a linear C₈-C₂₀ alkyl carboxylic acid, which can have one or more double bonds. A fatty acid amide is derived from a fatty acid and an amine. A fatty acid carboxylate salt is a salt derived from a fatty acid and a base. A fatty acid ester is an ester of a fatty acid. In certain circumstances, the composition can be substantially free of emollients or moisturizers which can leave a residue on a surface treated with the composition, or on a surface of an object that contacts the composition. An emollient is a skin conditioner which helps the skin retain moisture by creating a barrier on the skin surface and reducing excessive water loss. Emollients can include oils, essential oils, fats, waxes, paraffins, lipids, vitamins and silicone compounds. A moisturizer is a skin conditioner which hydrates the skin by adding moisture to the skin. Moisturizers can include glycerin, panthenol, propylene glycol, or glycerol.

The composition can include a surfactant. Surfactant can act as a solubilizer and as a wetting agent to reduce surface tension. The surfactant can include, for example, an anionic surfactant, a cationic surfactant, a nonionic surfactant or a mixture of surfactants. The surfactant can include, for example, an ampholytic or amphoteric surfactant, which can have anionic or cationic properties depending upon the pH of the composition. The composition can include about 0.001% to about 10%, about 0.01% to about 5%, or about 0.05% to about 1% by weight of surfactant.

A nonionic surfactant has a long chain alkyl group or an alkylated aryl group, and a hydrophilic chain including a sufficient number (for example, 1 to about 30) of ethoxy and/or propoxy moieties. Examples of classes of nonionic surfactants include alkylphenol ethoxylate, polyethylene glycol ethers of methyl glucose, polyethylene glycol ethers of sorbitol, ethylene oxide-propylene oxide block copolymers, condensation products of ethylene oxide with long chain amines or amides, or mixtures thereof. Examples of nonionic surfactants can include, for example, nonylphenol ethoxylate, ethoxylated octylphenol, or ethoxylated dodecylphenol, or mixtures thereof. Additional surfactants are listed in McCutcheon's Emulsifiers and Detergents, 1993 Annuals, (hereafter McCutcheon's), McCutcheon Division, MC Publishing Co., Glen Rock, N.J., pp. 1-246 and 266-272, which is incorporated herein by reference in its entirety.

The composition can include a preservative. The preservative can include, for example, paraben which is an ester of para-hydroxybenzoic acid. Examples include methyl paraben, ethyl paraben, propylparaben, butylparaben, sodium methyl paraben, or sodium propyl paraben. A suitable preservative can be methyl paraben. The composition can include about 0.001% to about 10%, about 0.01% to about 5% or about 0.01% to about 1% by weight of the preservative.

The composition can include a lower alcohol. The lower alcohol can be a water soluble alcohol containing one to four carbon atoms. Examples of alcohol, include methanol, ethanol, propanol or isopropyl alcohol. The alcohol can also provide disinfecting properties to the composition. The composition can include about 0.001% to about 20%, 0.01% to about 10% or 0.01% to about 5% by weight of the lower alcohol.

The pH of the composition when formulated can be at least 7.0, greater than 7.1, less than 10.0, or between 7.2 and 9.0. For example, the pH of the composition can be about 7.5, about 8.0 or about 8.5. Concentrated compositions can be formulated which contain greater than about 5%, by weight, of ingredients in the concentrated composition. The concentrated composition can be diluted to a specific concentration of ingredients in the composition. For example, ingredients in the composition can be less than about 15%, less than about 10% or less than about 5% by weight in the composition.

The composition can include other additives, such as dyes, fragrances, thickeners, viscosity modifiers, buffering agents, foam stabilizers, colorants, antioxidants, foam enhancers, chelating agents, opacifiers, gelling agents, vitamins or similar classes of optional ingredients.

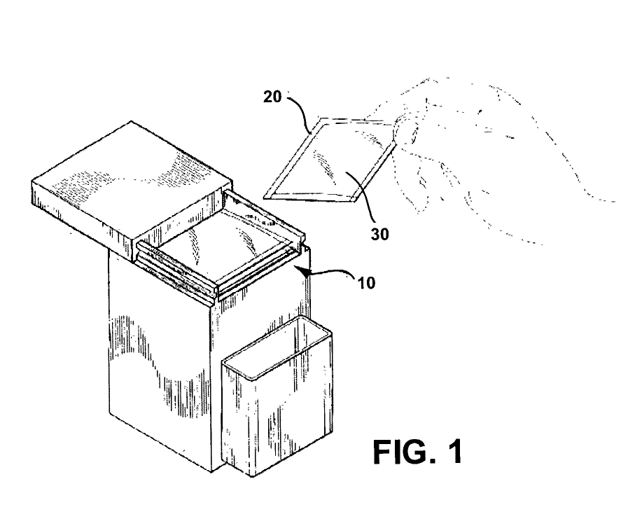

The composition can be delivered as, for example, a wet sheet composition or a hand wash or a tool wash to neutralize acid on a surface. As a wet sheet, the composition is in or on a sheet. Referring to FIG. 1, a container 10 includes sheet 20. The sheet 20 includes a composition 30 for controlling acidity on a surface. The sheet 20 can be pre-moistened or infused with composition 30. The sheet can be a woven or nonwoven web formed of synthetic fibers, or combination of synthetic fibers thereof suitable for use as a pre-moistened sheet. Woven refers to an intermeshed web of directionally oriented fibers. Nonwoven refers to a web of directionally or randomly oriented fibers, bonded by friction, and/or cohesion and/or adhesion. Suitable synthetic fibers include fibers commonly used in textiles, including polyester, polypropylene, and viscose fibers. Blending two types of fibers can give the sheets a silky-soft feel, which desirable for hand wiping.

The container 10 can be, for example, a box, a bag, a cylinder, a plastic cylinder, a sealable enclosure, or a bottle. The sheet 20 can be dispensed from the container 10 from a series of stacked, folded, or “pop-up” sheets. The sheets can be folded in any of various known folding patterns, such as C-folding or Z-folding. A Z-folded configuration enables a folded stack of sheets to be interleaved with overlapping portions.

Alternatively, the composition can be pumped or sprayed from a container onto a surface from, for example, a spray can or a pump dispenser. The surface can be, for example, a skin surface of a mammal or any inanimate surface, for example, a tool surface of a tool which is used later to contact an object.

The composition can maintain the pH of a surface above 7 for a period of up to 2 hours, up to 5 hours, or up to 7 hours. The method can include single-use application with the sheet to wipe the surface and render the pH of the surface neutral to mildly alkaline pH. Repeated application with the sheet can maintain the pH of a surface neutral to mildly alkaline pH. For example, the composition can be reapplied to the surface after a first application to the surface to maintain the pH of the surface above 7. For example, the hands of the user can be wiped prior to handling an object such as a craft item, a work of art or historical artifact or photograph.

The following Example is representative of the composition.

### EXAMPLE

A composition is shown in Table 1. A preparation vessel was filled with deionized water. The phosphoric acid (85% by weight solution in water) was added to the vessel with mixing. Triethanolamine (85%) was added to the vessel and pH of the solution was adjusted followed addition of sodium bicarbonate. A pre-mixed solution of methyl paraben and ethyl alcohol was added to the above vessel. Nonylphenol ethoxylate (9 mol) was added to the vessel and the pH of the composition was balanced to 7.5 by addition of acid.

TABLE 1

| Ingredient | Percent of ingredient by weight (%) |
|---|---|
| Deionized water | 95.10 |
| Phosphoric acid | 0.10 |
| Triethanolamine | 0.50 |
| Sodium bicarbonate | 0.10 |
| Methyl paraben | 0.10 |
| Ethyl alcohol | 4.0 |
| Nonylphenol ethoxylate | 0.10 |

Other embodiments are within the scope of the following claims.

What is claimed is:

1. An acid neutralizing composition comprising an aqueous solution including an amine and an acid and being substantially free of fatty acids, fatty acid amides, fatty acid carboxylate salts and fatty acid esters.

2. The composition of claim 1 wherein the amine is selected from a group consisting of a primary amine, secondary amine, tertiary amine, alkylamine, alkanol amine, diamine, dialkylamine, dialkanolamine, alkylalkanolamine, trialkylamine, trialkanolamine, dialkyl alkanolamine, alkyl dialkanolamine, ammonia and mixtures thereof.

3. The acid neutralizing composition of claim 1 further comprising alkali metal hydroxides, alkaline earth metal hydroxides, alkali metal carbonates, alkaline earth metal carbonates, alkali metal bicarbonates, alkali earth metal bicarbonates or mixtures thereof.

4. The composition of claim 1 wherein the amine is a trialkanolamine.

5. The composition of claim 4 wherein the trialkanolamine is triethanolamine.

6. The composition of claim 1 wherein the acid is an inorganic acid.

7. The composition of claim 1 wherein the acid is selected from a group consisting of acetic acid, phosphoric acid, orthophosphoric acid, metaphosphoric acid or phosphorous acid, citric acid, adipic acid, malic acid, malonic acid, phthalic acid, oxalic acid, succinic acid, sorbic acid, cinnamic acid, benzoic acid, hydroxybenzoic acid, glycolic acid, lactic acid, malic acid, muriatic acid, sulfamic acid, tartaric acid, glucuronic acid, and mixtures thereof.

8. The composition of claim 7 wherein the acid is selected from a group consisting of phosphoric acid, orthophosphoric acid, metaphosphoric acid and phosphorous acid.

9. The composition of claim 7 wherein the acid is phosphoric acid.

10. The composition of claim 1 further comprising a surfactant.

11. The composition of claim 9 wherein the surfactant is a nonionic surfactant.

12. The composition of claim 11 wherein the nonionic surfactant is alkylphenol ethoxylate.

13. The composition of claim 1 further comprising a lower alcohol.

14. The composition of claim 13 wherein the alcohol is ethyl alcohol.

15. The composition of claim 1 further comprising a preservative.

16. The composition of claim 15 wherein the preservative is methyl paraben.

17. The composition of claim 1 wherein the amine is 0.001% to 1% by weight of the composition.

18. The composition of claim 1 wherein the acid is 0.001% to 1% by weight of the composition.

19. The composition of claim 1 wherein the amine is trialkanolamine, the acid is phosphoric acid and the composition includes a nonionic surfactant.

20. A method of neutralizing acid on a surface comprising:
contacting a surface with a composition comprising an aqueous solution including an amine and an acid and being substantially free of fatty acids, fatty acid amides, fatty acid carboxylate salts and fatty acid esters, thereby increasing pH of the surface.

21. The method of claim 20 wherein the amine is selected from the group consisting of ammonia, a primary amine, secondary amine, tertiary amine, alkylamine, alkanol amine, diamine, dialkylamine, dialkanolamine, alkylalkanolamine, trialkylamine, trialkanolamine, dialkyl alkanolamine, alkyl dialkanolamine and mixtures thereof.

22. The method of claim 20 further comprising alkali metal hydroxides, alkaline earth metal hydroxides, alkali metal carbonates, alkaline earth metal carbonates, alkali metal bicarbonates, alkali earth metal bicarbonates or mixtures thereof.

23. The method of claim 20 wherein the acid is selected from a group consisting of acetic acid, phosphoric acid, orthophosphoric acid, metaphosphoric acid or phosphorous acid, citric acid, adipic acid, malic acid, malonic acid, phthalic acid, oxalic acid, succinic acid, sorbic acid, cinnamic acid, benzoic acid, hydroxybenzoic acid, glycolic acid, lactic acid, malic acid, muriatic acid, sulfamic acid, tartaric acid, glucuronic acid and mixtures thereof.

24. The method of claim 20 wherein the surface is skin of a mammal.

25. The method of claim 20 wherein contacting the surface includes leaving a surface substantially free of residue.

26. The method of claim 20 wherein the pH of the surface increases from less than 7 to between 7 and 10.

27. The method of claim 20 wherein the pH of the surface increases from between 5.5 and 6.9 to between 7.0 and 8.0.

28. The method of claim 20 wherein the pH of the surface remains at or above pH 7 for at least 2 hours.

29. The method of claim 20 wherein the surface is a tool surface.

30. The method of claim 20 wherein contacting the surface includes wiping the surface with a sheet comprising the composition.

31. An acid neutralizing composition comprising:
an amine and a pH adjuster in an aqueous medium wherein the composition is substantially free of moisturizers or emollients.

32. The acid neutralizing composition of claim 31 wherein the pH adjuster includes an acid or a salt, or mixtures thereof.

33. The composition of claim 31 wherein pH adjuster is a salt selected from the group consisting of soluble carbonate salts and soluble bicarbonate salts.

34. A acid neutralizing sheet comprising:
a sheet;
a composition including an aqueous solution including an amine and an acid and being substantially free of fatty acids, fatty acid amides, fatty acid carboxylate salts and fatty acid esters contacting the sheet; and
a container retaining the sheet.

35. An acid neutralizing composition consisting essentially of water, an amine, an inorganic acid, a carbonate salt and a nonionic surfactant.

36. The composition of claim 35 wherein the composition contains a preservative.

37. A method of maintaining pH of a surface on a mammal comprising:
applying a surface of a mammal with an effective amount of a composition comprising a pH adjusting agent being substantially free of fatty acids, fatty acid amides, fatty acid carboxylate salts and fatty acid esters to render the pH of the surface of the mammal neutral to mildly alkaline pH.

38. The method of claim 37 wherein the composition is applied to the surface of the mammal with a first sheet.

39. The method of claim 37, further comprising reapplying the effective amount of the composition to the surface of the mammal to maintain the pH on the surface.

40. The method of claim 39 wherein the composition is reapplied to the surface of the mammal with a second sheet.
